(19) United States
(12) Patent Application Publication
(10) Pub. No.: US 2017/0053168 A1
(43) Pub. Date: Feb. 23, 2017

(54) METHOD AND SYSTEM FOR THE OPTIMIZATION OF PLANT GROWTH

(71) Applicant: Murgyver Consulting Ltd., Vernon (CA)

(72) Inventor: Murray Ford, Vernon (CA)

(73) Assignee: MURGYVER CONSULTING LTD., Vernon (CA)

(21) Appl. No.: 14/832,897

(22) Filed: Aug. 21, 2015

(51) Int. Cl. G06K 9/00

(52) U.S. Cl. CPC G06K 9/00657; G06K 9/00134

(57) ABSTRACT

A system for optimizing plant growth comprises at least one camera adapted to record at least one visual image of the plant and a processor configured to select at least one feature of the plant and a plant condition corresponding to the at least one feature. The system further comprises a connection between the at least one camera and the processor adapted to transmit the at least one visual image to a processor and an output for outputting the plant condition. A method for optimizing plant growth comprises recording at least one visual image of the plant with at least one camera, transmitting the at least one visual image to a processor and with the processor, selecting at least one feature of the plant. The method further comprises, with the processor, selecting a plant condition corresponding to the at least one feature and outputting the plant condition.

### BACKGROUND OF THE INVENTION

1. Field of Invention

The present invention relates generally to object identification and classification and in particular, a method and a system for identifying features of or on the surface plants to optimize growth.

2. Description of Related Art

In the field of commercial agriculture, monitoring growth and detecting disease are important metrics for optimizing plant yields. Disease and pest detection and identification is a necessary quality-assurance measure that is performed from the planting stage, through the seedling, growth and flowering stages, right through to the packaging of the final product.

Traditionally this is done by visual inspection of the plants and surrounding media by human inspectors who have the appropriate qualifications. Additionally, in order to increase yields, growers will stringently monitor various input and output parameters used to control plant growth during the growth process. Growers may use a variety of methods to monitor, log, and analyze growth and climate data during all stages of the growing process in order to increase yields and optimize efficiency.

Since the evaluation of the plant requires that a surface of the plant be evaluated, a common method is to have a human inspector visually evaluate said surface with the naked eye, or using an optical enhancement tool such as a microscope. The inspector must then determine if an abnormality exists, the type of abnormality present, be it an indicator of nutrient imbalance, pest, or other biological invasion, and then determine the appropriate action to correct the abnormality. Reliance upon a human eye is a potential source for error or inconsistency.

### SUMMARY OF THE INVENTION

According to a first embodiment of the present invention there is disclosed a method for optimizing plant growth comprising recording at least one visual image of the plant with at least one camera, transmitting the at least one visual image to a processor and with the processor, selecting at least one feature of the plant. The method further comprises, with the processor, selecting a plant condition corresponding to the at least one feature and outputting the plant condition.

The condition may be presented to a user. The condition may be outputted to a growth control system operable to adjust at least one growth condition for the plant.

The feature may comprise a color of on at least a portion of the surface thereof. The feature may comprise the shape of a foreign body located on the surface thereof. The feature may comprise the size of at least a portion of the plant. The size of the at least a portion of the plant may be compared to a previously measured size of the plant to determine growth rate thereof.

The at least one image may be recorded by a plurality of camera. The plurality of cameras may be arranged in an array. The plurality of images may be recorded by a single camera at each of a plurality of position.

According to a further embodiment of the present invention there is disclosed a system for optimizing plant growth comprising at least one camera adapted to record at least one visual image of the plant and a processor configured to select at least one feature of the plant and a plant condition corresponding to the at least one feature. The system further comprises a connection between the at least one camera and the processor adapted to transmit the at least one visual image to a processor and an output for outputting the plant condition.

The system may further comprise a growth control system operable to receive the plant condition and adjust at least one growth condition for the plant. The at least one camera may comprise a plurality of cameras arranged in an array about the plant. The system may further comprise a frame adapted to position the at least one camera to a plurality of positions about the plant. The system may further comprise a drive adapted to reposition the frame and the at least one cameral to the plurality of positions about the plant.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a side view of an apparatus for use in the system and method of FIG. 1 according to a first embodiment of the present invention.

FIG. 2 is a perspective view of the apparatus for use in the system and method of FIG. 1.

FIG. 3 is a perspective view of a plant having a plurality of camera positions arranged thereabout for use in the system and method for optimizing plant during growth according to a first embodiment of the present invention.

FIG. 4 is an illustration of a system for optimizing plant growth according to a further embodiment of the present invention.

FIG. 5 is a flow chart of a method for optimizing plant growth according to a first embodiment of the present invention.

FIG. 6 is a flow chart of a method for analysing color of the plant in the method of FIG. 5.

FIG. 7 is a flow chart of a method for evaluating the color of the plant in the method of FIG. 5.

FIG. 8 is a flow chart of a method for identifying pests on the plant of the method of FIG. 5.

### DETAILED DESCRIPTION

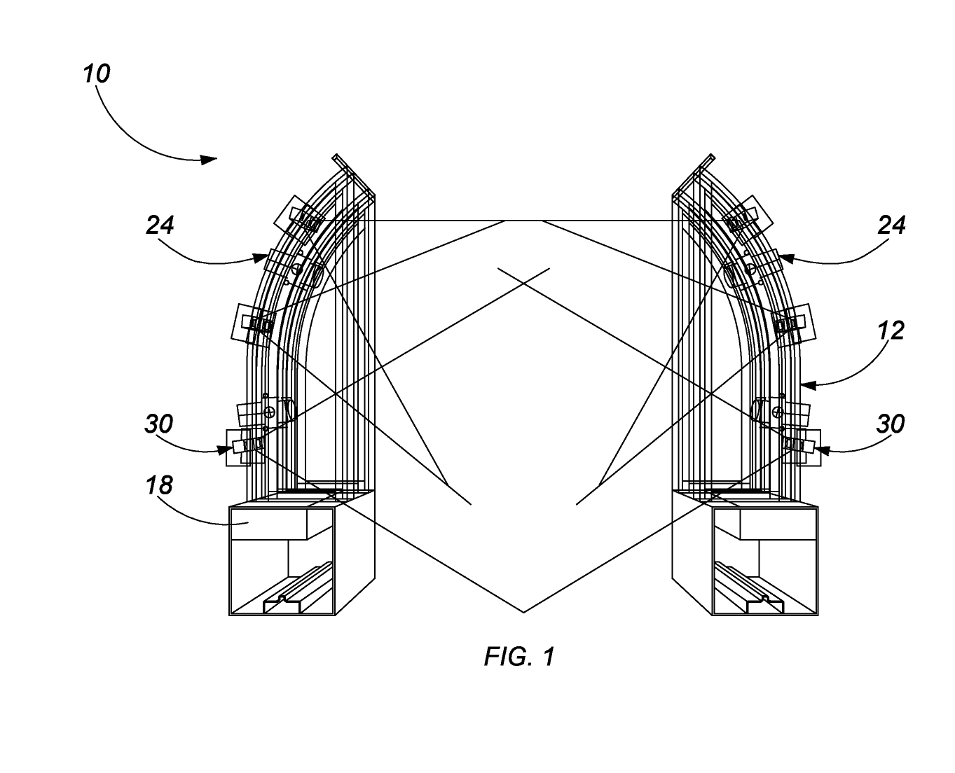

Referring to FIGS. 1 through 3, a system for measuring a plant 8 according to a first embodiment of the invention is shown generally at 10. The system generally comprises frame 12, at least one vision unit 16, and processor circuit 18. The frame 12 is a robust structural body, which may be formed of any suitable material, such as, by way of non-limiting example, metal, plastic or composite materials, which supports the vision unit 16. The vision units 16 as will be further described below are adapted to capture an image and/or three dimensional rendering of the plant for further processing are supported by articulating supports 20 upon the frame 12 according to known methods. In particular, the vision units may be supported on the frame 12 so as to be operable to be mobile and adjustable about the plant 8 in rotation, pitch, yaw, and roll. The image and/or 3D rendering of the plant is utilized by the processor circuit 18 to analysis, classify and diagnose the condition of the plant to determine an optimized growing condition and/or treatment.

The vision units 16 are selected to capture a desired image and/or 3D rendering of the plant as set out above. In particular, the vision units may comprise optical image cameras 24 and may be of any conventional known type such as, by way of non-limiting example, color high-speed high-resolution cameras the vision unit may also comprise a light source 22 operable to provide light to the plant 8 for use in capturing the image and/or 3D rendering and/or a laser scanners operable to scan and record geometric data about the plant.

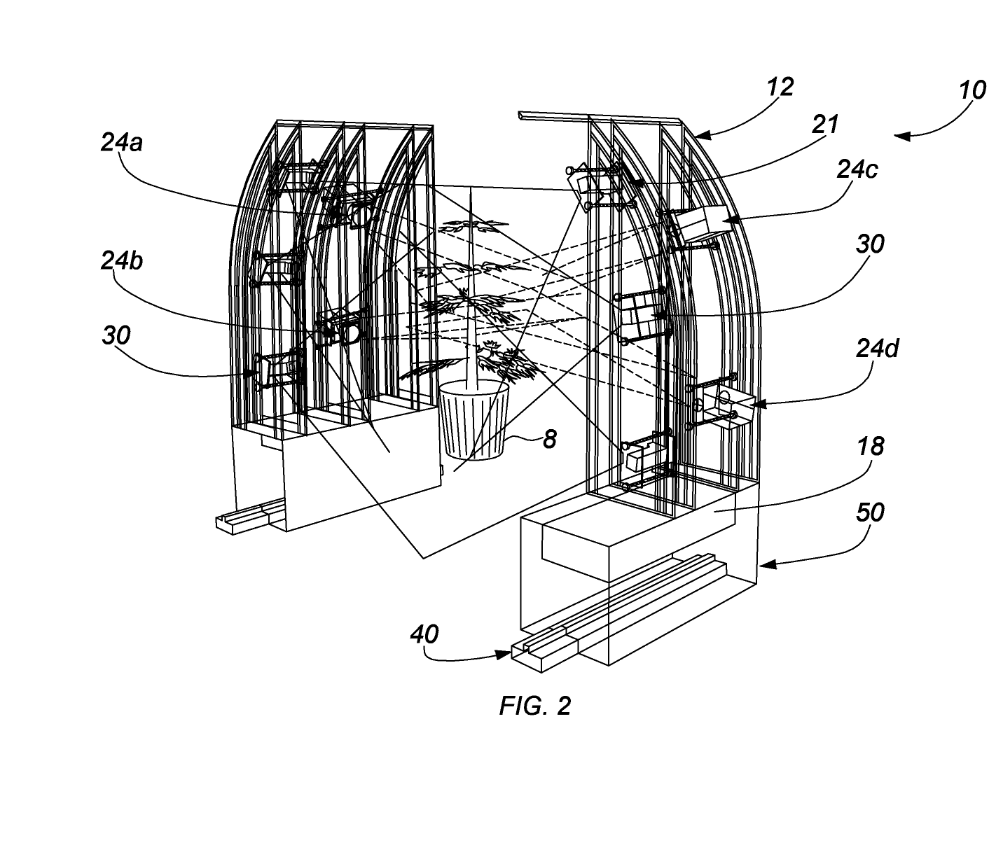

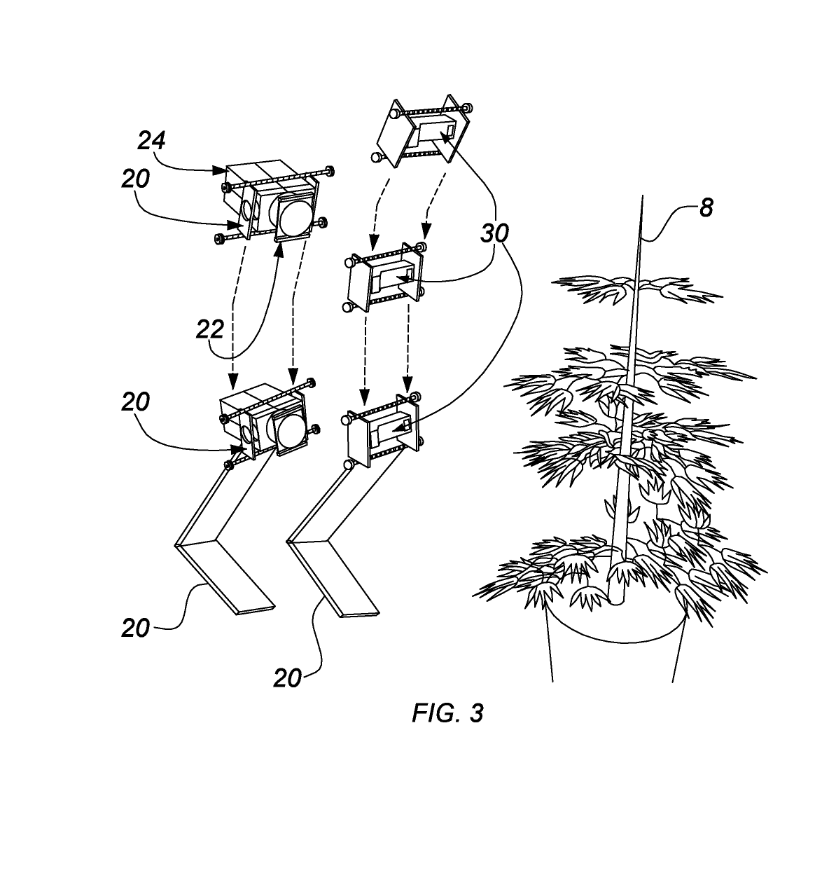

As illustrated in FIG. 2, the system may include a plurality of cameras 24a-24d distributed along the frame around the plant so as to be placed to be operable to capture an image and/or 3D rendering in combination with each other. Alternatively, as illustrated in FIG. 3 a single camera 24 and/or laser 30 may be moved between different positions about the plant upon an articulating arm 20 or one or more of the cameras, light sources or laser scanners may be mounted on carriages 21 repositionable about the frame 12 through any known means, such as tracks or the like.

In a specific embodiment given by way of example for clarification purpose, the vision unit 16 is on a moveable apparatus 40 and comprises four linear high speed color high-resolution cameras 24 divided into two vision sub-units located on either side of the vertical axis, positioned such that images may be repeatedly captured as the vision sub-units are continually re-positioned via computer control in a parabolic motion about the object of interest. The vision unit 16 is attached to a solid frame structure 12. The frame structure is mounted to a guide-rail assembly 40. The guide-rail assembly 40 is used to guide and propel the frame structure and vision sub-units in a pre-determined path.

It will be appreciated that through use of multiple image units 16, a full 360 view of the plant may be obtained. In particular, the independent camera capture points 24a-24e, or collective repetitive capture from a single cameras, provide a plurality of images or data which may be utilized to form a comprehensive image and/or 3D rendering of the plant as a whole according to known means of image processing.

The processor circuit 18 comprises a master computer, a plurality of independent high-speed computers linked to the cameras 24 and a module dedicated to shape and object identification, and an optimization computer.

The processor circuit 18 may monitor the position and location of the vision unit 16 and/or the vision sub-units as parameters. These data may be input either manually or automatically.

In the embodiment illustrated in FIG. 1, the processor circuit 18 may be located within a chamber 50 provided in the frame. Optionally, the processor circuit 18 may be alternatively be separately or remotely located from the frame.

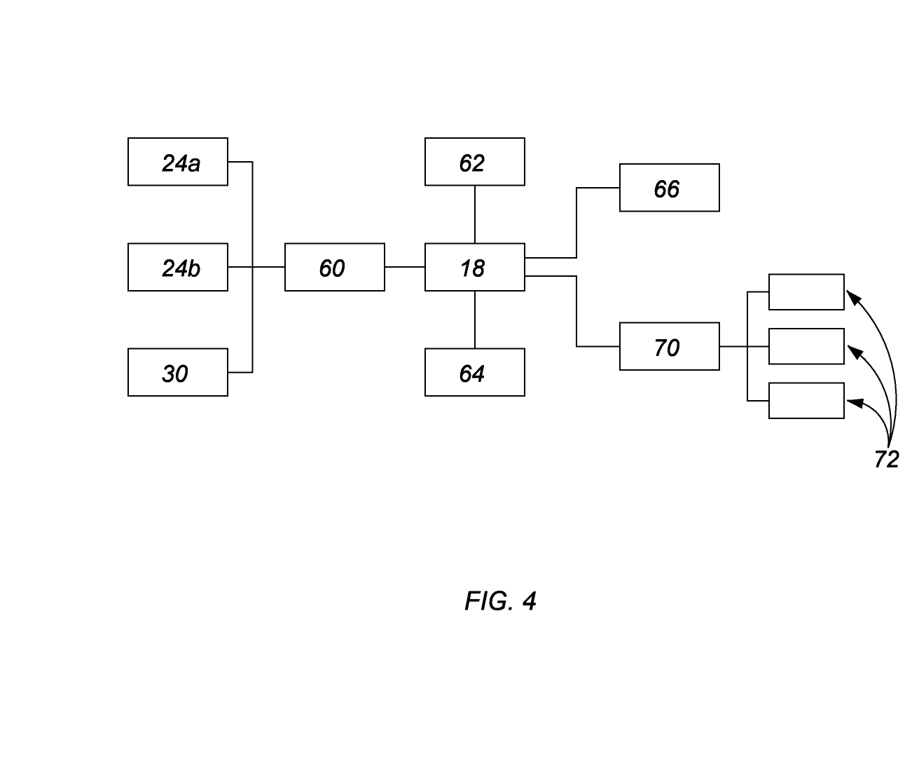

Turning now to FIG. 4, the system for optimizing the growth of the plant comprises one or more camera 24a through e and/or one or more laser 30 for capturing an image or topography of the plant. The images and/or topography may be processed and/or combined by an image processor 60 as is commonly known to provide a unitary image and/or 3D rendering of the plant 8. The image and/or 3D rendering is then provided or otherwise transmitted to the processor circuit 18. The processor circuit 18 includes an associated memory 64 and may optionally include a user input 62 operable to receive parameter from a user. The system may also include an output 66 operable to output a result to a user or a growth control system 70 operable to control and adjust one or more growth condition of the plant through one or more control module 72. By way of non-limiting example, the control modules may comprise light sources, water valves or fertilizer and/or pesticide control systems.

More generally, in this specification, including the claims, the term “processor circuit” is intended to broadly encompass any type of device or combination of devices capable of performing the functions described herein, including (without limitation) other types of microprocessors, microcontrollers, other integrated circuits, other types of circuits or combinations of circuits, logic gates or gate arrays, or programmable devices of any sort, for example, either alone or in combination with other such devices located at the same location or remotely from each other, for example. Additional types of processor circuits will be apparent to those ordinarily skilled in the art upon review of this specification, and substitution of any such other types of processor circuits is considered not to depart from the scope of the present invention as defined by the claims appended hereto.

Computer code comprising instructions for the processor(s) to carry out the various embodiments, aspects, features, etc. of the present disclosure may reside in the memory 64. In various embodiments, the processor circuit 18 can be implemented as a single-chip, multiple chips and/or other electrical components including one or more integrated circuits and printed circuit boards. The processor circuit 18 together with a suitable operating system may operate to execute instructions in the form of computer code and produce and use data. By way of example and not by way of limitation, the operating system may be Windows-based, Mac-based, or Unix or Linux-based, among other suitable operating systems. Operating systems are generally well known and will not be described in further detail here.

Memory 64 encompasses one or more storage mediums and generally provides a place to store computer code (e.g., software and/or firmware) and data that are used by the system 10. It may comprise, for example, electronic, optical, magnetic, or any other storage or transmission device capable of providing the processor circuit 18 with program instructions. Memory 64 may further include a floppy disk, CD-ROM, DVD, magnetic disk, memory chip, ASIC, FPGA, EEPROM, EPROM, flash memory, optical media, or any other suitable memory from which processor circuit 18 can read instructions in computer programming languages.

Memory 64 may include various other tangible, non-transitory computer-readable media including Read-Only Memory (ROM) and/or Random-Access Memory (RAM). As is well known in the art, ROM acts to transfer data and instructions uni-directionally to the processor circuit 18, and RAM is used typically to transfer data and instructions in a bi-directional manner. In the various embodiments disclosed herein, RAM includes computer program instructions that when executed by the processor circuit 18 cause the processor circuit 18 to execute the program instructions described in greater detail below.

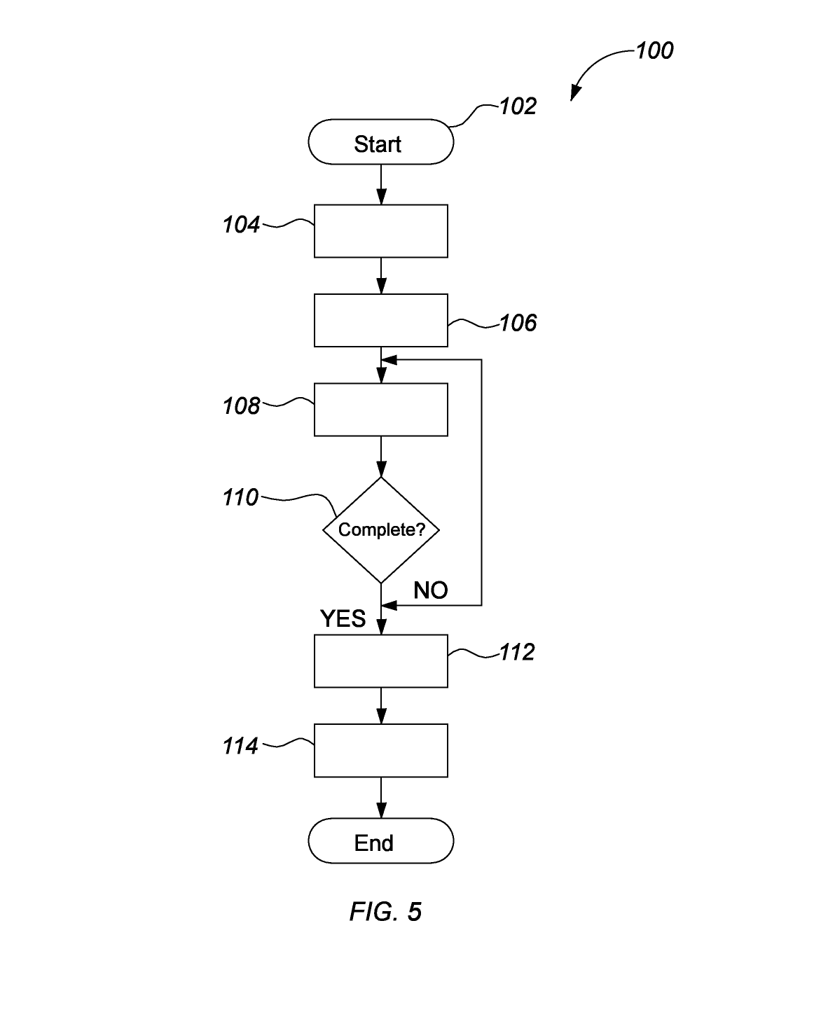

FIG. 5 is a flowchart depicting the actions taken by the system processor circuit 18 after acquisition of the plant image of a method 100 according to an embodiment of the present invention. After initializing in step 102, the processor circuit 18 receives the image from the camera 24 or image processor 60 in step 104. The processor circuit 18 may then optionally receive from a user input 62 or from memory 64, the identification of the plant in question and criteria to be evaluated in step 106. The processor circuit 18 then compares the image against each criteria in step 108 to determine if a particular condition exists as will be more fully described below and repeats this process until all criteria have been assessed in step 110. After all criteria have been assessed, the processor circuit determines a condition or compiles diagnosis of the plant in step 112 and outputs this diagnosis or condition to a user or the growth control system 70 in step 114.

The system according to the present invention is adapted to assess and diagnose one or more condition of the plant. In particular, the condition may be any growth condition of the plant, such as, by way of non-limiting example, nutrient imbalance, slow growth, inadequate water sunlight or fertilizer or presence of pests and disease.

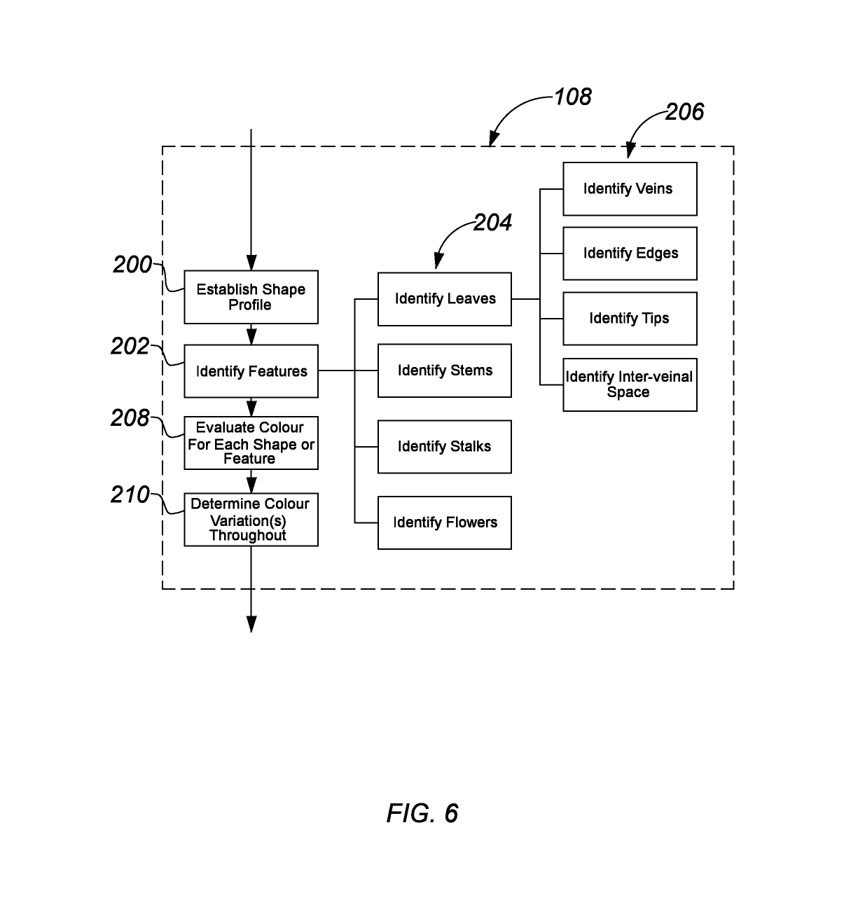

Turning now to FIG. 6, an exemplary process for assessing one criteria of the plant 8 is illustrated. In the example of FIG. 6, the color of different portions of the plant are assessed to determine a growth health or condition of the plant. In particular, the image is processed by the processor circuit 18 by first establishing a shape profile for the plant 8 in step 200. In particular, in this step the overall shape of the plant 8 is confirmed and analysed to confirm identity. Thereafter separate structural of the plant are identified through any known image identification means to locate the different portions of the plant in step 202. As illustrated in FIG. 6, the structural elements may be identified as a first level 204 being the larger structural elements and optionally at a secondary level 206 being the smaller structural elements.

Thereafter the color of each structural element is determined in step 208 and the overall color average and variation levels determined in step 210. Such average color levels may be then looked up in the memory 64 to determine if water, light and fertilizer levels are correct or to identify indicators of nutrient imbalance or pest and disease presence.

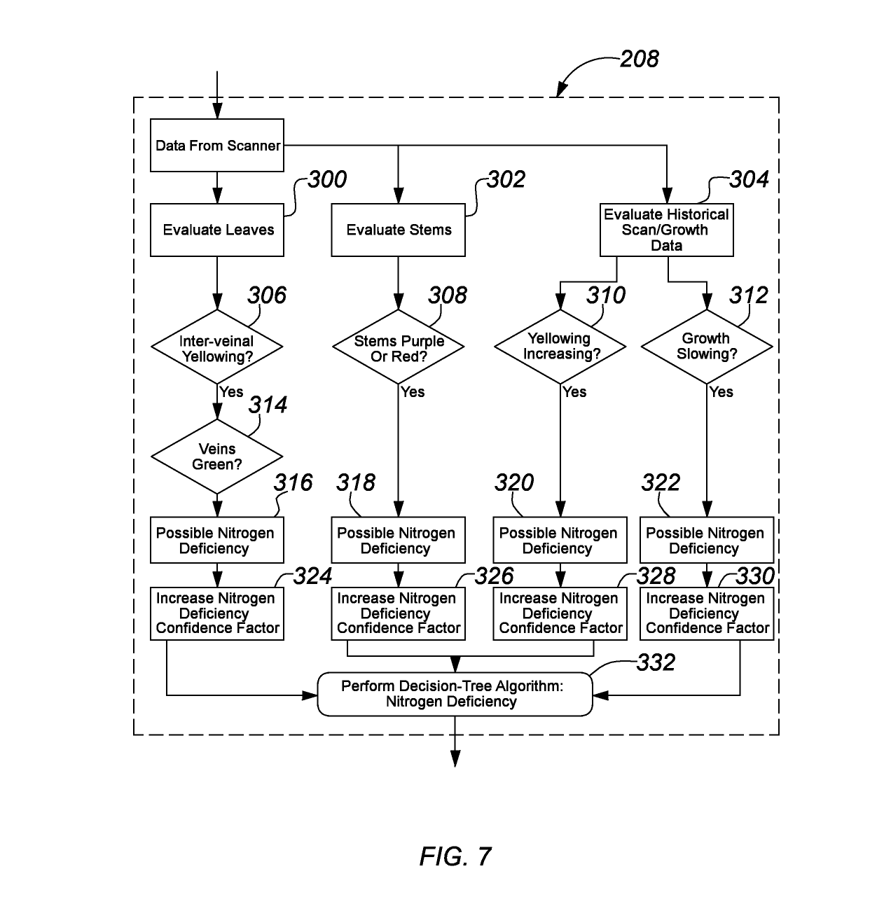

Turning to FIG. 7, an example of a process for analysing the color of each structural element above is illustrated. In particular as illustrated in FIG. 7, the color of each element may be analysed separately in 300, 302 and 304 against a specified color criteria 306, 308, 310, 312 and 314. A condition associated with each color for that structural element may then be looked up in the memory 64 in steps 316, 318, 320 and 322 and a factor or indicator provided to the overall health of the plant in 324, 326, 328 and 330. Thereafter each of the factors may be compiled or added together to determine an overall analysis in 322. It will be appreciated that the factors and weights provided to each color of each structural element will vary from plant to plant as well as from condition to condition.

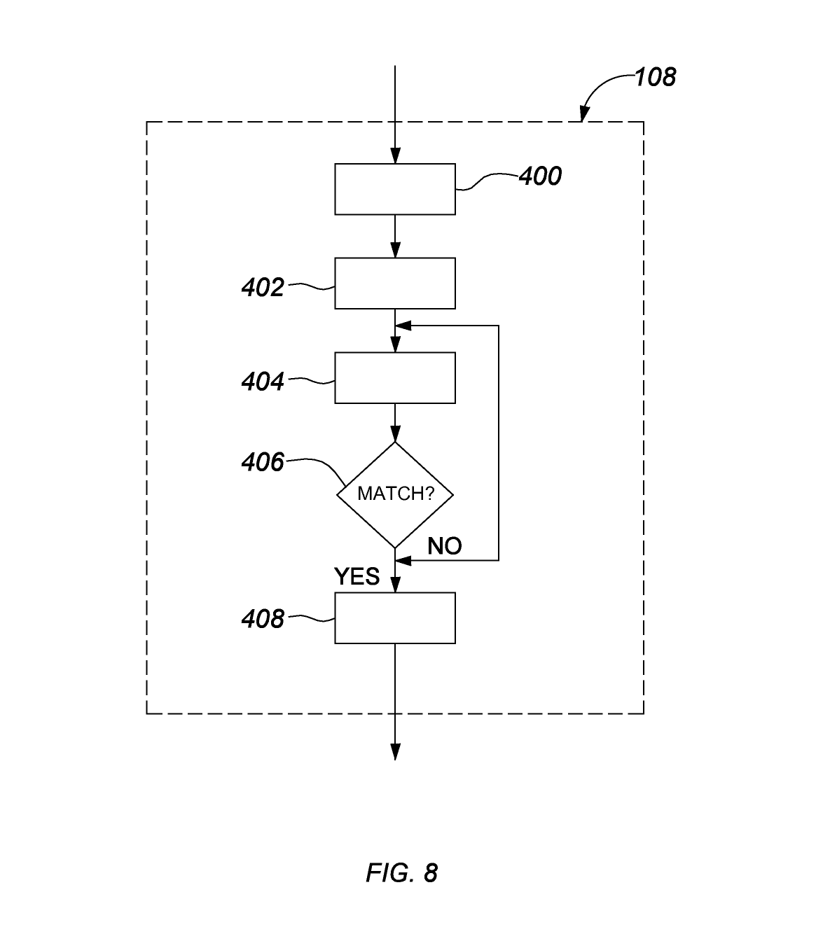

Turning now to FIG. 8, an exemplary process for assessing one criteria of the plant 8 is illustrated. In the example of FIG. 8, the presence of a pest may be determined. After the image has been provided to the processor circuit 18. The processor circuit looks up the shape profile for that plant in step 400. Thereafter anomalous shapes on the surface of the plant are identified in step 402 as foreign bodies. In steps 404 and 406, the processor first compares the foreign bodies to a shape stored in the memory 64 corresponding to known foreign bodies. If the anomalous shape is a match for the compared shape, then the processor circuit outputs an identification of the foreign body in step 408. If the anomalous shape does not match, the processor circuit continues to compare the anomalous shape until a match is found or the list of known foreign bodies in memory 64 has been exhausted. In the present description, the term foreign body may be understood to encompass any organism or object foreign to the plant, including without limitation, insects, animals, or other pests, other plants, fungi, infections, inorganic objects and anomalous growths including tumours and the like.

From the foregoing, people in the art will appreciate the system and method of the present invention facilitates data collection on all reflective surfaces on an object to evaluate with a minimum of equipment ingeniously configured in the available space, and allows classification of growing plants with a high precision level and a low error margin. Obviously, the system may be an expert system for plant husbandry.

It should now be apparent that the vision unit 16 allows a precise measurement of the shape and appearance of an object, such as a growing plant, on all reflective surfaces thereof and/or on a periphery thereof, by collecting data measurements including the thickness, the width, the length and therefore shape of the object. Furthermore, the vision unit allows to detect a number of nutrient imbalances in the growing plant such as nitrogen, phosphorus, potassium, magnesium, zinc, calcium, boron, chlorine, cobalt, copper, iron, manganese, molybdenum, selenium, silicon, sulfur, and other micro-nutrient imbalances by analyzing the data generated by the vision unit 16.

Furthermore, the vision unit 16 allows detection of a number of pests and diseases common to plants, such as fungus and molds, and insects such as spider mites, aphids, beetles, caterpillars, loopers, leaf hoppers, leaf miners, fungus gnats, mealy bugs, scales, maggots, slugs, snails, thrips, whiteflies, downy mildew, blight, fusarium wilt, virticullium wilt, and viruses for example. The data collected by the cameras of the vision sub-units, as well as data collected by the measurement means, are transmitted to the processing unit 18 for treatment by the optimization software, which combines all available collected measurements to yield an optimal growth analysis and classification of each independent leaf, stem, stalk, and flower of the plant as they are identified by the system 10.

It is to be noted that the present system 10 allows handling of 3d objects of a variety of shape and geometry. In particular, the system may be adapted to a range of plant sizes and types, by obvious adjustment of the vision unit 20 or scale of the structural frame 12.

While specific embodiments of the invention have been described and illustrated, such embodiments should be considered illustrative of the invention only and not as limiting the invention as construed in accordance with the accompanying claims.

What is claimed is:

1. A method for optimizing plant growth comprising:
recording at least one visual image of the plant with at least one camera;
transmitting said at least one visual image to a processor;
with said processor, selecting at least one feature of the plant;
with said processor, selecting a plant condition corresponding to said at least one feature; and
outputting said plant condition.

2. The method of claim 1 wherein said condition is presented to a user.

3. The method of claim 1 wherein said condition is outputted to a growth control system operable to adjust at least one growth condition for said plant.

4. The method of claim 1 wherein said feature comprises a color of on at least a portion of the surface thereof.

5. The method of claim 1 wherein said feature comprises the shape of a foreign body located on the surface thereof.

6. The method of claim 1 wherein said feature comprises the size of at least a portion of said plant.

7. The method of claim 6 wherein said size of said at least a portion of said plant is compared to a previously measured size of said plant to determine growth rate thereof.

8. The method of claim 1 wherein said at least one image is recorded by a plurality of camera.

9. The method of claim 8 wherein said plurality of cameras are arranged in an array.

10. The method of claim 1 wherein said plurality of images are recorded by a single camera at each of a plurality of position.

11. A system for optimizing plant growth comprising:
at least one camera adapted to record at least one visual image of the plant;
a processor configured to select at least one feature of the plant and a plant condition corresponding to said at least one feature;
a connection between said at least one camera and said processor adapted to transmit said at least one visual image to a processor; and
an output for outputting said plant condition.

12. The system of claim 11 further comprising a growth control system operable to receive said plant condition and adjust at least one growth condition for said plant.

13. The system of claim 11 wherein said at least one camera comprises a plurality of cameras arranged in an array about said plant.

14. The system of claim 11 further comprising a frame adapted to position said at least one camera to a plurality of positions about said plant.

15. The system of claim 14 further comprising a drive adapted to reposition said frame and said at least one cameral to said plurality of positions about said plant.
